(19) United States
(12) Patent Application Publication
(10) Pub. No.: US 2023/0176886 A1
(43) Pub. Date: Jun. 8, 2023

(54) METHODS AND APPARATUS TO MANAGE WORKLOAD DOMAINS IN VIRTUALIZED COMPUTING ENVIRONMENTS

(71) Applicant: VMWARE, INC., Palo Alto, CA (US)

(72) Inventors: Naren Lal, Bangalore (IN); Ranganathan Srinivasan, Bangalore (IN)

(21) Appl. No.: 17/544,919

(22) Filed: Dec. 7, 2021

(51) Int. Cl. G06F 9/455

(52) U.S. Cl. CPC G06F 9/45558; G06F 2009/4557

(57) ABSTRACT

Methods, apparatus, systems, and articles of manufacture are disclosed to manage workload domains in virtualized computing environments. An example non-transitory computer readable medium comprises instructions that, when executed, cause a machine to at least: in response to detecting a first workload domain that is over-utilized, transmit a message to a message broker; detect a second workload domain that is under-utilized; and transfer a host from the second workload domain to the first workload domain.

### FIELD OF THE DISCLOSURE

This disclosure relates generally to virtualized computing and, more particularly, to methods and apparatus to manage workload domains in virtualized computing environments.

### BACKGROUND

The virtualization of computer systems provides numerous benefits such as the execution of multiple computer systems on a single hardware computer, the replication of computer systems, the extension of computer systems across multiple hardware computers, etc. “Infrastructure-as-a-Service” (also commonly referred to as “IaaS”) generally describes a suite of technologies provided by a service provider as an integrated solution to allow for elastic creation of a virtualized, networked, and pooled computing platform (sometimes referred to as a “cloud computing platform”). Enterprises may use IaaS as a business-internal organizational cloud computing platform (sometimes referred to as a “private cloud”) that gives an application developer access to infrastructure resources, such as virtualized servers, storage, and networking resources. By providing ready access to the hardware resources required to run an application, the cloud computing platform enables developers to build, deploy, and manage the lifecycle of a web application (or any other type of networked application) at a greater scale and at a faster pace than ever before.

Cloud computing environments may be composed of many processing units (e.g., servers). The processing units may be installed in standardized frames, known as racks, which provide efficient use of floor space by allowing the processing units to be stacked vertically. The racks may additionally include other components of a cloud computing environment such as storage devices, networking devices (e.g., switches), etc.

### BRIEF DESCRIPTION OF THE DRAWINGS

FIG. 1 is a block diagram of an example computing environment in which methods and apparatus disclosed herein may operate.

FIG. 2 is a block diagram of an example implementation of the of the host orchestrator 110.

FIGS. 3-5 are flowcharts representative of example machine readable instructions that may be executed by example processor circuitry to implement the host orchestrator.

FIG. 6 is a block diagram of an example processing platform including processor circuitry structured to execute the example machine readable instructions of FIGS. 3-5 to implement the host orchestrator.

FIG. 7 is a block diagram of an example implementation of the processor circuitry of FIG. 6.

FIG. 8 is a block diagram of another example implementation of the processor circuitry of FIG. 6.

FIG. 9 is a block diagram of an example software distribution platform (e.g., one or more servers) to distribute software (e.g., software corresponding to the example machine readable instructions of FIGS. 3-5) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name. As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events. As used herein, “processor circuitry” is defined to include (i) one or more special purpose electrical circuits structured to perform specific operation(s) and including one or more semiconductor-based logic devices (e.g., electrical hardware implemented by one or more transistors), and/or (ii) one or more general purpose semiconductor-based electrical circuits programmed with instructions to perform specific operations and including one or more semiconductor-based logic devices (e.g., electrical hardware implemented by one or more transistors). Examples of processor circuitry include programmed microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs). For example, an XPU may be implemented by a heterogeneous computing system including multiple types of processor circuitry (e.g., one or more FPGAs, one or more CPUs, one or more GPUs, one or more DSPs, etc., and/or a combination thereof) and application programming interface(s) (API(s)) that may assign computing task(s) to whichever one(s) of the multiple types of the processing circuitry is/are best suited to execute the computing task(s).

### DETAILED DESCRIPTION

Cloud computing is based on the deployment of many physical resources across a network, virtualizing the physical resources into virtual resources, and provisioning the virtual resources for use across cloud computing services and applications. Example systems for virtualizing computer systems are described in U.S. patent application Ser. No. 15/198,914, entitled “HARDWARE MANAGEMENT SYSTEMS FOR DISAGGREGATED RACK ARCHITECTURES IN VIRTUAL SERVER RACK DEPLOYMENTS,” filed Jun. 30, 2016, and U.S. patent application Ser. No. 15/280,348, entitled “METHODS AND APPARATUS TO DEPLOY WORKLOAD DOMAINS IN VIRTUAL SERVER RACKS,” filed Sep. 29, 2016, which are hereby incorporated by reference herein in their entireties.

When starting up a cloud computing environment or adding resources to an already established cloud computing environment, data center operators struggle to offer cost-effective services while making resources of the infrastructure (e.g., storage hardware, computing hardware, and networking hardware) work together to achieve simplified installation/operation and optimize the resources for improved performance. Prior techniques for establishing and maintaining data centers to provide cloud computing services often require customers to understand details and configurations of hardware resources to establish workload domains in which to execute customer services.

Workload domains are logical units that carve up the compute, network, and storage resources of a virtual computing (e.g., cloud computing) system. The logical units are groups of hosts managed by administration service instances with characteristics for redundancy and best practices. For example, a virtual machine may be added to a workload domain to utilize the compute resources assigned to the workload domain. For example, when a customer requests to run one or more services in a cloud computing environment, one or more workload domains may be created based on resources in the shared pool of configurable computing resources. A first workload domain, referred to as the management domain, may be created by default during initialization. A cloud services software stack may be deployed within the management domain. Additional infrastructure virtual machines which provide common services, such as backup or security appliances, can also be deployed in the management domain.

A computing environment (e.g., a data center, a cloud environment, a hybrid computing environment, etc.) may include multiple deployed workload domains. In such a system, each workload domain could be made up of multiple hosts (e.g., VMWARE ESXI hosts). When resources of one of the workload domains are heavily utilized to handle the traffic associated with the workload domain, more servers are typically added to meet the resource demands. The addition of servers adds additional costs. However, while the noted workload domain may benefit from additional resources, other workload domains (e.g., computing environment such as a VMWARE CLOUD FOUNDATION environment) may be underutilized such that some hosts across the underutilized workload domain may be unused or underutilized. Methods and apparatus disclosed herein facilitate communication among workload domains and monitoring of resources of the workload domain by a resource monitor. For example, a message bus may be utilized for communication. When resources of a particular workload domain are heavily utilized, an example host orchestrator identifies an unutilized host from other connected workload domains. The underutilized host is removed from its current workload domain (e.g., and added to a free resource pool). According to some examples, the host orchestrator will then add this host to the heavily utilized workload domain to better-meet the demands. For example, It ensures resources available across the workload domains are utilized optimally.

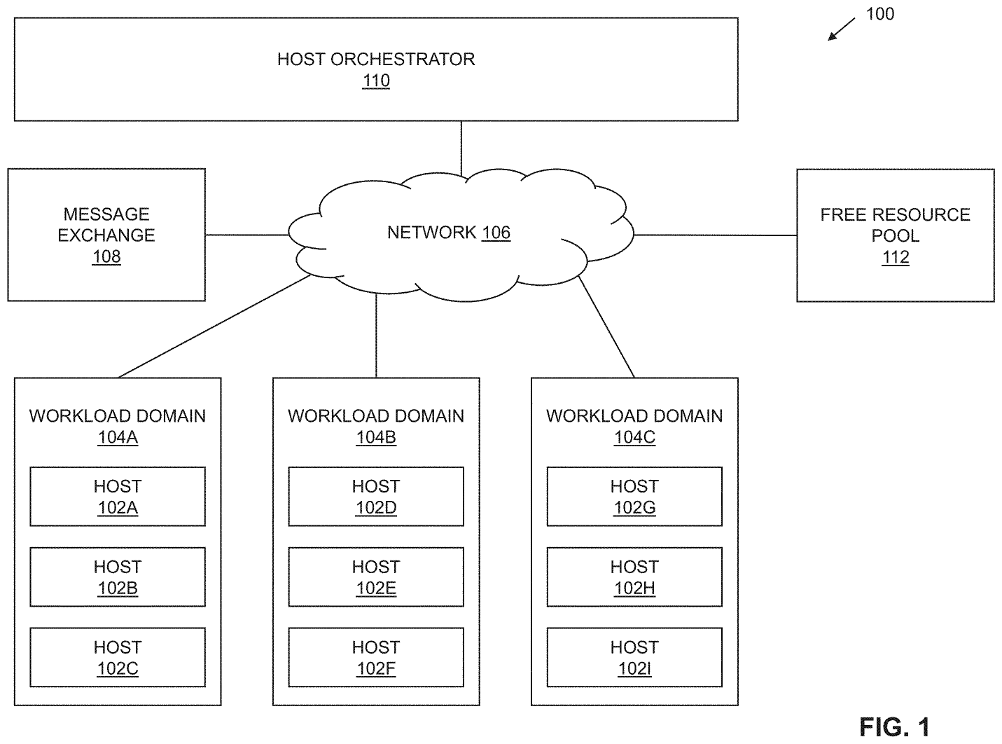

FIG. 1 is a block diagram of an example computing environment 100 in which methods and apparatus disclosed herein may operate. The example computing environment 100 includes a plurality of example computing hosts 102A-I that are included in a plurality of example workload domains 104A-C. the example computer environment 100 further includes an example network 106, an example message exchange 108, an example host orchestrator 110, and an example free resource pool 112.

The example hosts 102A-I are computer resources. For example, the hosts 102A-I may be blade servers installed in one or more server racks in a data center. Alternatively, the hosts 102A-I may be any type and quantity of computer resources. For example, the hosts 102A-I may include processing units, storage, network communication interfaces, etc.

The example hosts 102A-I are assigned to the logical units known as the workload domains 104A-C. The workload domains 104A-C provide a logical unit to group ones of the computing resources. According to the illustrated example, hosts assigned to a workload domain are only available for executing workloads of the particular workload domain (e.g., while assigned to one workload domain, a host is not available for executing workloads of another workload domain). For example, the example workload domain 104A includes the examples hosts 102A-C. Any other grouping or types of grouping may be employed. For example, a logical grouping of hosts known by any other name may be utilized. The workload domains 104A-C may span resources within a datacenter and/or may span distributed resources in multiple datacenters and/or locations (e.g., resources in the cloud, in the edge, on-premise, etc.). While three workload domains 104A-C are illustrated in the example of FIG. 1, any number of workload domains containing any number of hosts 102A-I may be implemented.

The example network 106 is a local area network that communicatively couples the components of the example computing environment 100. Alternatively, the network 106 may be any type of network such as a wide area network, a wireless network, a wired network, the Internet, etc. The network 106 may alternatively include any number and combination of network types.

The example message exchange 108 is a message broker that facilitates messaging communication among the components of the example computing environment 100. For example, the messaging exchange 108 may include one or more message queues. For example, the message exchange 108 may receive messages from one of the components, may store the messages in a queue, and may facilitate distribution of the messages to others of components that have subscribed to the messages. For example, messages may be posted (e.g., by the workload domain 104A) to a group, known as a channel, so that components (e.g., the host orchestrator 110) may subscribe to a channel of interest. Any type of messaging system may be utilized (e.g., any type of message broker, integration broker, interface engine, message-oriented middleware system etc.).

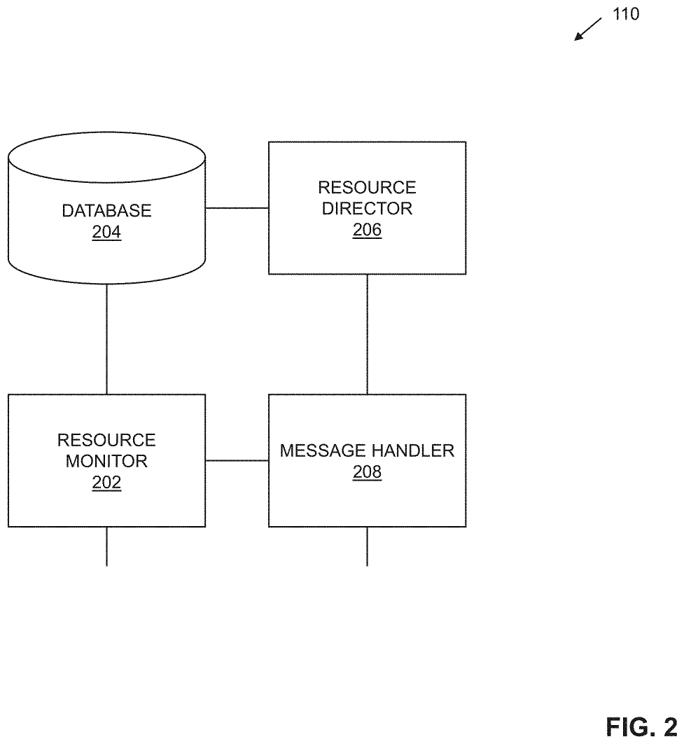

The example host orchestrator 110 manages the operation of the computing environment 100. According to the illustrated example, the host orchestrator 110 is implemented on a host of the computing environment (e.g., a host included in a data center that also includes one or more of the hosts 102A-I). Alternatively, the host orchestrator 110 may be implemented in any other manner such as a standalone server, a collection of hosts or servers, etc. In addition to managing the assignment of the hosts 102A-I to the workload domains 104A-C, the example host orchestrator 110 monitors resource utilization by the workload domains 104A-C (e.g., the utilization of the hosts 102A-I respectively assigned to the workload domains 104A-C) and facilitates re-alignment, reassignment, etc. of the hosts 102A-I to the workload domains 104A-C to meet the resource demands of the workload domains 104A-C. The host orchestrator 110 is described in further detail in conjunction with FIG. 2.

The example free resource pool 112 is a pooling of computing resources that are not currently assigned to a workload domain. For example, the free resource pool 112 may be a logical grouping (like a workload domain) to which resources may be assigned when they are not assigned to a particular workload domain. For example, resources assigned to the free resource pool 112 may be reassigned by the host orchestrator 110 to a particular workload domain to meet the resource demands of the workload domain. The free resource pool 112 may alternatively be a list, a table, a database, etc. that references resources that are free (e.g., not assigned) and may be allocated.

In operation, the host orchestrator 110 assigns ones of the hosts 102A-I to the workload domains 104A-C (e.g., as illustrated in FIG. 1). During operation, the resource demands of a workload domain may change (e.g., the first workload domain 104A may begin to demand more resources and the second workload domain 104B may demand less resources). Rather than pulling in resources from outside the current environment 100 (e.g., may adding hosts, connecting to hosts of other systems, etc.), the example host orchestrator 110 monitors the resource utilization of the various workload domains 104A-C to identify the additional demand and the reduced demand and, in response, to re-allocate resources from the second workload domain 104B to the first workload domain 104A. For example, the host orchestrator 110 may post a message identifying the second workload domain 104B indicating that unused/under-utilized resources should be moved to the free resource pool 112 and post a message identifying the first workload domain 104A indicating that the first workload domain 104A should add the resources in the free resource pool 112 to the first workload domain 104A.

FIG. 2 is a block diagram of an example implementation of the of the host orchestrator 110. The example host orchestrator 110 of FIG. 2 includes an example resource monitor 202, an example database 204, an example resource director 206, and an example message handler 208. While the example host orchestrator 110 includes the example resource monitor 202, the example database 204, the example resource director 206, and the example message handler 208, one or more of the components may be implemented independently of the host orchestrator 110 (e.g., implemented on their own host, server, etc.).

The example resource monitor 202 monitors the resource utilization of the workload domains 104A-C to detect under-utilized and over-utilized hosts. For example, the workload domains 104A-C send messages via the message bus of the message exchange 108 reporting the assigned hosts 102A-I and utilization levels and the messages may be collected (e.g., via subscription to an associated message channel). Alternatively, the resource monitor 202 may communicate with the workload domains 104A-C and/or a manager of the workload domains 104A-C (e.g., the host orchestrator 110) to determine resource utilization levels. In some examples, the resource monitor 202 determines that a host is under-utilized if the utilization of the host meets a threshold (e.g., if the resource utilization level is below 60%, if the resource utilization level is below 50%, if the resource utilization level is below 70%, if the free resource availability level is above 10%, if the free resource availability level is above 40%, etc.). The example resource monitor 202 stores resource utilization information in the example database 204. For example, the resource monitor 202 may store information about under-utilized hosts in the database 204, may store information about over-utilized hosts in the database 204, etc. The resource monitor 202 may additionally communicate resource utilization information to other components of the host orchestrator 110.

An example algorithm for the resource monitor 202 to determine a host availability starts with an assumption that only one hosts can be removed from a workload domain.

In an example, the first workload domain 104A has a current utilization of 30%. The resource monitor 202 may determine that utilization will increase to 45% if the first host 102A is removed from the first workload domain 104A. The example resource monitor 202 includes an offer threshold setting. In an example, the offer threshold may be set to 60%. In such an example, server availability may be calculated as (Projected Utilization/Offer Threshold). According to the example, 45%/60%=0.75. The example resource monitor 202 determines if the server availability is less than 1. According to the illustrated example, if the server availability is less than one, one server (e.g., the first host 102A) is available to be moved to another workload domain that may be in need. If the server availability is not less than one, no servers are available to be moved. Thus, according to the example, one server is available.

In a second example, the first workload domain 104A has a current utilization of 50%. The resource monitor 202 may determine that utilization will increase to 62.5% if the first host 102A is removed from the first workload domain 104A. The offer threshold may be set to 60%. In such an example, server availability may be calculated as (Projected Utilization/Offer Threshold). According to the example, 62.5%/50%=1.25. The example resource monitor 202 determines if the server availability is less than 1. According to the illustrated example, if the server availability is less than one, one server (e.g., the first host 102A) is available to be moved to another workload domain that may be in need. If the server availability is not less than one, no servers are available to be moved. Thus, according to the example, no servers are available. However, if the offer threshold is increased to 70%, the server availability is calculated as 62.5%/70%<1 and, thus, one server is available.

The example resource monitor 202 may keep a table in the database that is dynamically computed and updated based on real time utilization date over a range of time and then averaged. For example, an example table:

| Offer | First | Second | Third |
|---|---|---|---|
| Threshold/ | Workload | Workload | Workload |
| Utilization | Domain | Domain | Domain |
| 60% | 0 | 0 | 0 |
| 65% | 1 | 0 | 0 |
| 70% | 1 | 0 | 0 |
| 75% | 1 | 0 | 0 |
| 80% | 1 | 0 | 1 |

The example database 204 is a database of resource information. The example database 204 is communicatively coupled to the resource monitor 202 and the resource director 206. The database 204 may alternatively be implemented by any other type of data storage such as a file storage, a disk storage, a memory, and/or any combination of storage solutions.

The example resource director 206 directs the assignment of resources within the computing system. For example, the resource director 206 directs the assignment of hosts 102A-I to the workload domains 104A-C. According to the illustrated example, the resource director 206 controls the assignment of hosts 102A-I to the workload domains 104A-C using messaging via the message handler 208.

The example message handler 208 sends and receives messages in the messaging system managed by the message exchange 108. For example, the message handler 208 transmits messages to a message channel and receives messages by subscribing to channels. For example, the message handler 208 may subscribe to a channel associated with the workload domains 104A-C.

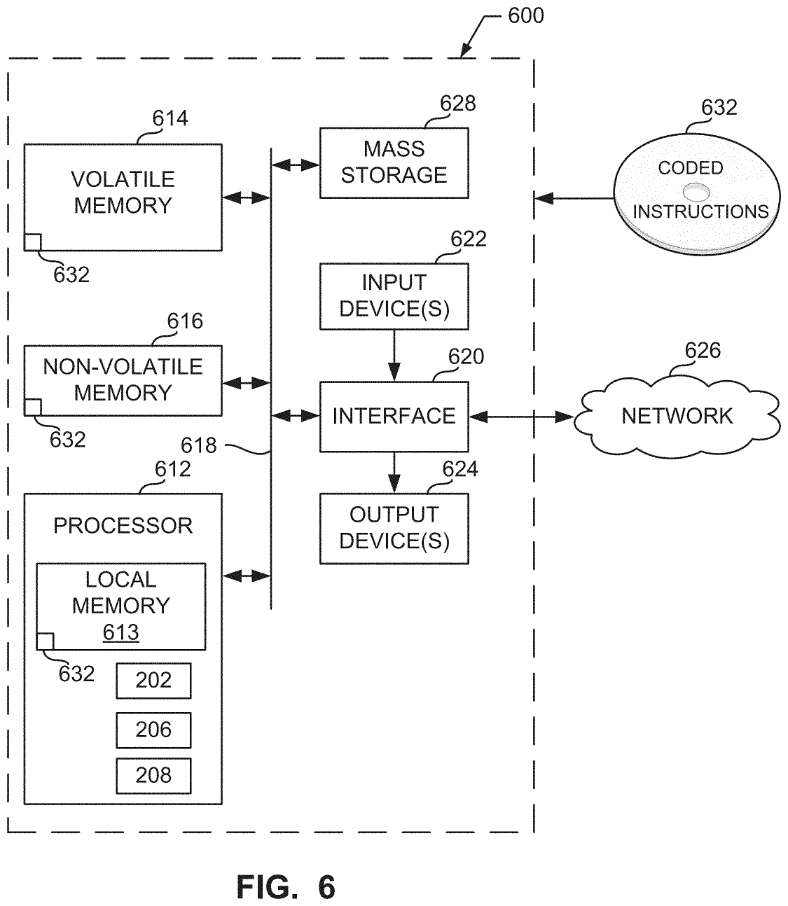

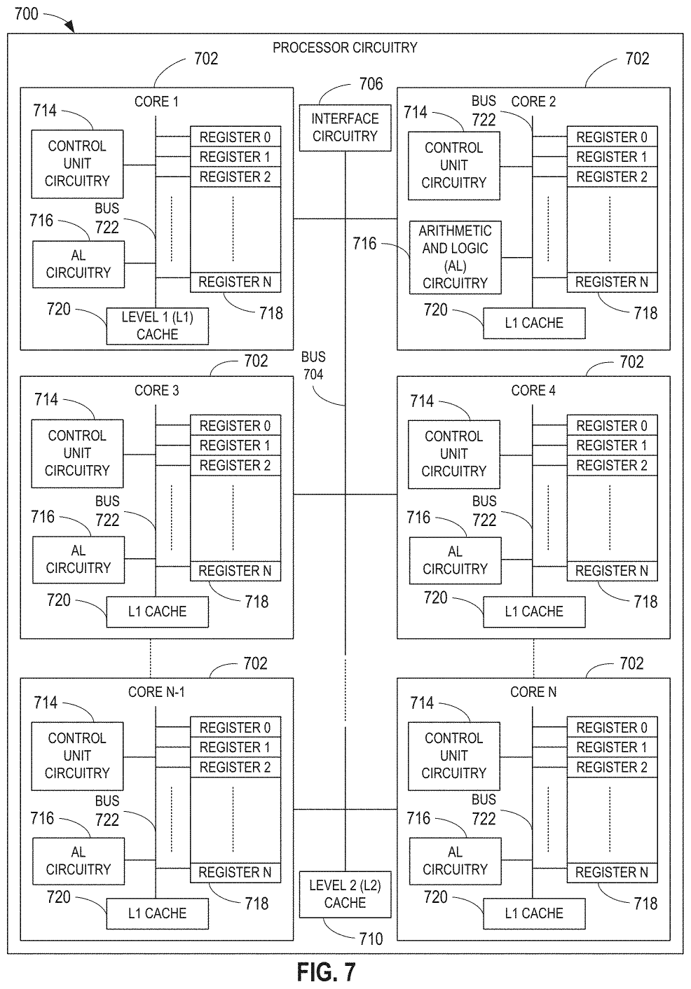

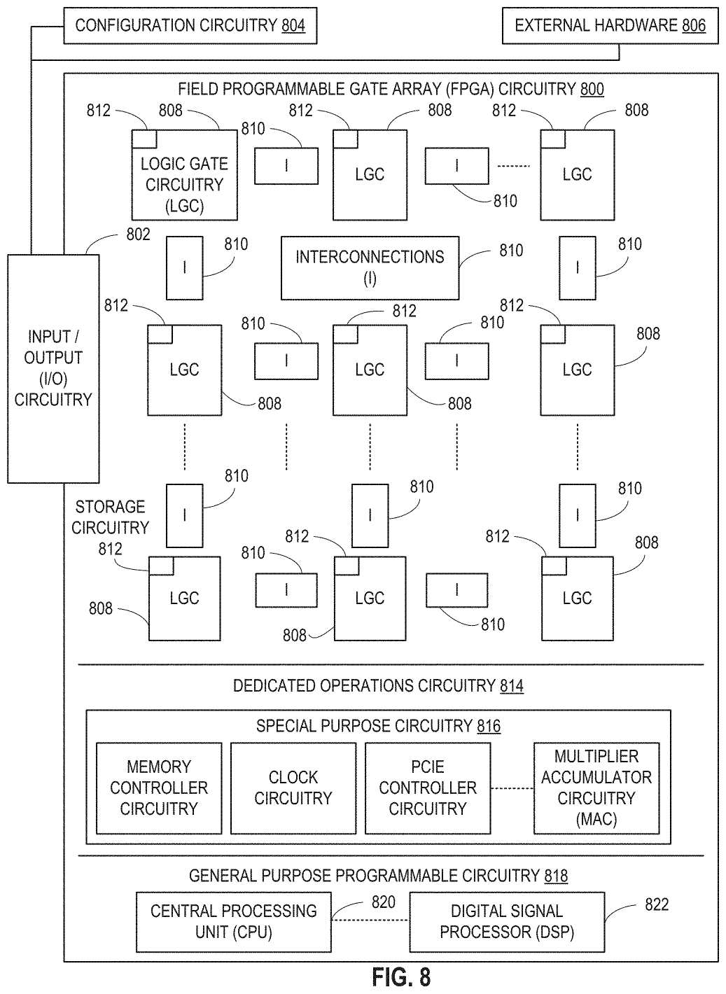

In some examples, the host orchestrator 110 includes means for monitoring resources. For example, the means for monitoring resources may be implemented by the resource monitor 202 (e.g., resource monitor circuitry). In some examples, the resource monitor circuitry 202 may be implemented by machine executable instructions such as that implemented by at least blocks <to be updated> executed by processor circuitry, which may be implemented by the example processor circuitry 612 of FIG. 6, the example processor circuitry 700 of FIG. 7, and/or the example Field Programmable Gate Array (FPGA) circuitry 800 of FIG. 8. In other examples, the resource monitor circuitry 202 is implemented by other hardware logic circuitry, hardware implemented state machines, and/or any other combination of hardware, software, and/or firmware. For example, the resource monitor circuitry 202 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to perform the corresponding operation without executing software or firmware, but other structures are likewise appropriate.

In some examples, the host orchestrator 110 includes means for directing resources. For example, the means for directing resources may be implemented by the resource director 206 (e.g., resource director circuitry). In some examples, the resource directory circuitry 206 may be implemented by machine executable instructions such as that implemented by at least blocks <to be updated> executed by processor circuitry, which may be implemented by the example processor circuitry 612 of FIG. 6, the example processor circuitry 700 of FIG. 7, and/or the example Field Programmable Gate Array (FPGA) circuitry 800 of FIG. 8. In other examples, the resource directory circuitry 206 is implemented by other hardware logic circuitry, hardware implemented state machines, and/or any other combination of hardware, software, and/or firmware. For example, the resource directory circuitry 206 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to perform the corresponding operation without executing software or firmware, but other structures are likewise appropriate.

In some examples, the host orchestrator 110 includes means for handling messages. For example, the means for handling messages may be implemented by the message handler 208 (e.g., message handler circuitry). In some examples, the message handler circuitry 208 may be implemented by machine executable instructions such as that implemented by at least blocks <to be updated> executed by processor circuitry, which may be implemented by the example processor circuitry 612 of FIG. 6, the example processor circuitry 700 of FIG. 7, and/or the example Field Programmable Gate Array (FPGA) circuitry 800 of FIG. 8. In other examples, the message handler circuitry 208 is implemented by other hardware logic circuitry, hardware implemented state machines, and/or any other combination of hardware, software, and/or firmware. For example, the message handler circuitry 208 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to perform the corresponding operation without executing software or firmware, but other structures are likewise appropriate.

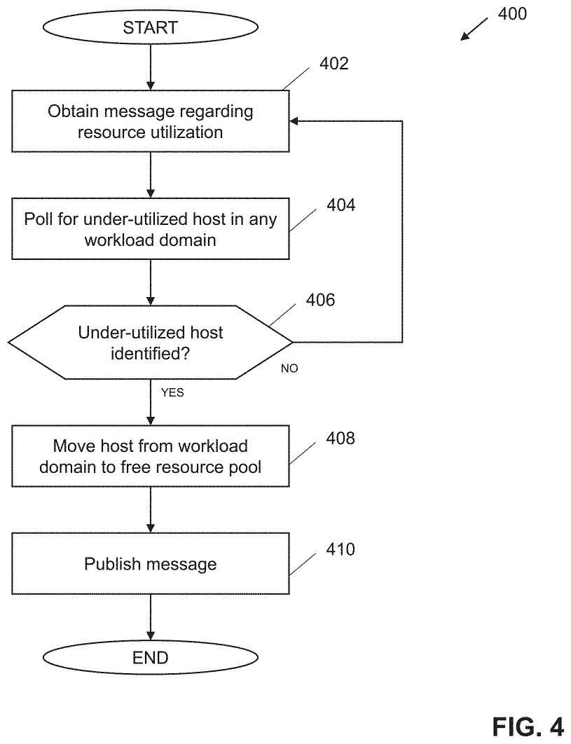

While an example manner of implementing the host orchestrator 110 of FIG. 1 is illustrated in FIG. 2, one or more of the elements, processes, and/or devices illustrated in FIG. 4 may be combined, divided, re-arranged, omitted, eliminated, and/or implemented in any other way. Further, the example resource monitor 202, the example resource director 206, the example message handler 208, and/or, more generally, the example host orchestrator 110 of FIG. 1, may be implemented by hardware, software, firmware, and/or any combination of hardware, software, and/or firmware. Thus, for example, any of the example resource monitor 202, the example resource director 206, the example message handler 208, and/or, more generally, the example host orchestrator 110 of FIG. 1, could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). When reading any of the apparatus or system claims of this patent to cover a purely software and/or firmware implementation, at least one of the example resource monitor 202, the example resource director 206, the example message handler 208, and/or, more generally, the example host orchestrator 110 of FIG. 1 is/are hereby expressly defined to include a non-transitory computer readable storage device or storage disk such as a memory, a digital versatile disk (DVD), a compact disk (CD), a Blu-ray disk, etc., including the software and/or firmware. Further still, the example host orchestrator 110 of FIG. 1 may include one or more elements, processes, and/or devices in addition to, or instead of, those illustrated in FIG. 2, and/or may include more than one of any or all of the illustrated elements, processes and devices.

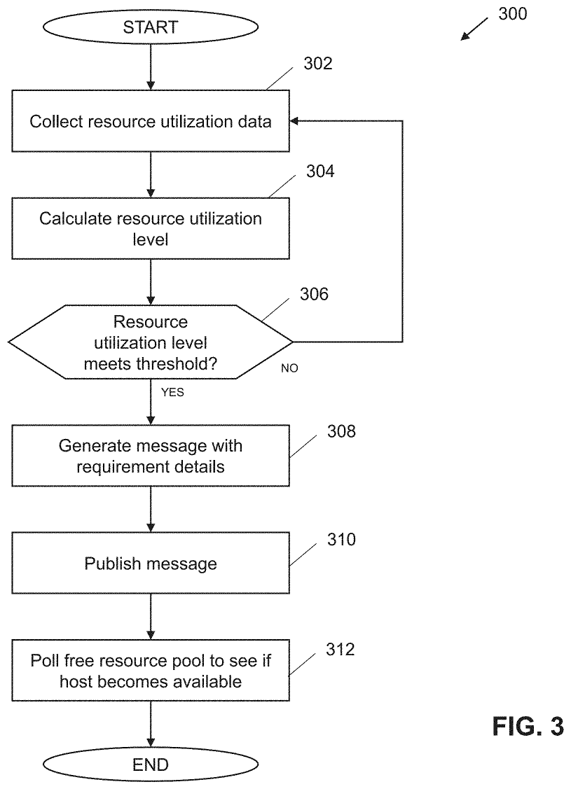

Flowcharts representative of example hardware logic circuitry, machine readable instructions, hardware implemented state machines, and/or any combination thereof for implementing the host orchestrator 110 are shown in FIGS. 3-5. The machine readable instructions may be one or more executable programs or portion(s) of an executable program for execution by processor circuitry, such as the processor circuitry 612 shown in the example processor platform 600 discussed below in connection with FIG. 6 and/or the example processor circuitry discussed below in connection with FIGS. 7 and/or 8. The program may be embodied in software stored on one or more non-transitory computer readable storage media such as a CD, a floppy disk, a hard disk drive (HDD), a DVD, a Blu-ray disk, a volatile memory (e.g., Random Access Memory (RAM) of any type, etc.), or a non-volatile memory (e.g., FLASH memory, an HDD, etc.) associated with processor circuitry located in one or more hardware devices, but the entire program and/or parts thereof could alternatively be executed by one or more hardware devices other than the processor circuitry and/or embodied in firmware or dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN) gateway that may facilitate communication between a server and an endpoint client hardware device). Similarly, the non-transitory computer readable storage media may include one or more mediums located in one or more hardware devices. Further, although the example program is described with reference to the flowcharts illustrated in FIG. 3-5, many other methods of implementing the example host orchestrator 110 may alternatively be used. For example, the order of execution of the blocks may be changed, and/or some of the blocks described may be changed, eliminated, or combined. Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU), etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., as portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of machine executable instructions that implement one or more operations that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc., in order to execute the machine readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 3-5 may be implemented using executable instructions (e.g., computer and/or machine readable instructions) stored on one or more non-transitory computer and/or machine readable media such as optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms non-transitory computer readable medium and non-transitory computer readable storage medium is expressly defined to include any type of computer readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements or method actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 3 is a flowchart representative of example machine readable instructions and/or example operations 300 that may be executed and/or instantiated by processor circuitry to detect when resource utilization meets a threshold. The machine readable instructions and/or operations 300 of FIG. 3 begin at block 302, at which the resource monitor 202 collects resource utilization data (block 302). The example resource monitor 202 calculates a resource utilization level (block 304). For example, the resource monitor 202 may determine a percentage utilization of resources at a given moment in time, over a period of time, etc. The example resource monitor 202 determines if the resource utilization level meets a threshold (block 306). When the resource utilization level does not meet a threshold, control returns to block 302 to continue monitoring resources. When the resource utilization level meets the threshold, the example resource monitor 202 generates a message with requirement details (e.g., an indication of an amount of additional resources that may be needed) (block 308). The example resource monitor 202 publishes a message regarding the requirement details via the message handler 208 (block 310). The example resource director 206 then polls the free resource pool 112 to see if a host becomes available (block 312). For example, the resource monitor 202 may later post a message indicating that a workload domain includes a host that is under-utilized.

FIG. 4 is a flowchart representative is a flowchart representative of example machine readable instructions and/or example operations 400 that may be executed and/or instantiated by processor circuitry to detect an under-utilized resource in a workload domain. The machine readable instructions and/or operations 400 of FIG. 4 begin at block 402, at which the resource monitor 202 obtains a message regarding resource utilization of a workload domain via the message handler 208 (e.g., a message indicating that a workload domain is over-utilized). The resource director 206 polls for under-utilized hosts in any workload domain (block 404). The resource director 206 determines if any under-utilized hosts have been detected (block 406). For example, the algorithm described in conjunction with FIG. 2 may be utilized to determine if a workload domain includes a host that can be moved. When there are no under-utilized hosts, control returns to block 402. When any under-utilized host is identified, the resource director 206 moves the host from its current workload domain to the free resource pool (block 408). The resource director 206 causes a message regarding the resource moved to the free resource pool to be published via the message handler 208 (block 410).

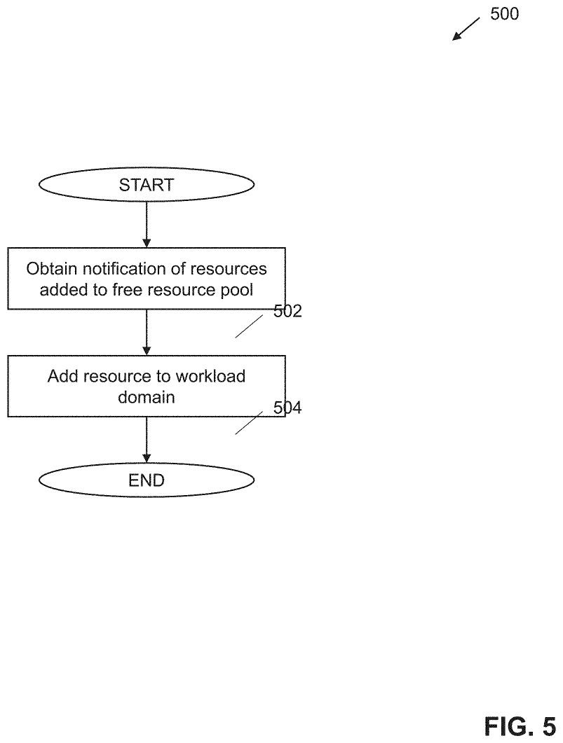

FIG. 5 is a flowchart representative is a flowchart representative of example machine readable instructions and/or example operations 500 that may be executed and/or instantiated by processor circuitry to move available resources to a workload domain. The machine readable instructions and/or operations 500 of FIG. 5 begin at block 502, at which the message handler 208 receives a message of resources added to the free resource pool. The example resource handler 206 adds the free resource to the workload domain identified as needing resources in FIG. 3 (block 504).

FIG. 6 is a block diagram of an example processor platform 600 structured to execute and/or instantiate the machine readable instructions and/or operations of FIGS. 3-5 to implement the host orchestrator 110 of FIG. 1. The processor platform 600 can be, for example, a server, a personal computer, a workstation, a self-learning machine (e.g., a neural network), a mobile device (e.g., a cell phone, a smart phone, a tablet such as an iPad′), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing device.

The processor platform 600 of the illustrated example includes processor circuitry 612. The processor circuitry 612 of the illustrated example is hardware. For example, the processor circuitry 612 can be implemented by one or more integrated circuits, logic circuits, FPGAs microprocessors, CPUs, GPUs, DSPs, and/or microcontrollers from any desired family or manufacturer. The processor circuitry 612 may be implemented by one or more semiconductor based (e.g., silicon based) devices. In this example, the processor circuitry 612 implements the resource monitor 202, the resource director 206, and the message handler 208.

The processor circuitry 612 of the illustrated example includes a local memory 613 (e.g., a cache, registers, etc.). The processor circuitry 612 of the illustrated example is in communication with a main memory including a volatile memory 614 and a non-volatile memory 616 by a bus 618. The volatile memory 614 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 616 may be implemented by flash memory and/or any other desired type of memory device. Access to the main memory 614, 616 of the illustrated example is controlled by a memory controller 617.

The processor platform 600 of the illustrated example also includes interface circuitry 620. The interface circuitry 620 may be implemented by hardware in accordance with any type of interface standard, such as an Ethernet interface, a universal serial bus (USB) interface, a Bluetooth® interface, a near field communication (NFC) interface, a PCI interface, and/or a PCIe interface.

In the illustrated example, one or more input devices 622 are connected to the interface circuitry 620. The input device(s) 622 permit(s) a user to enter data and/or commands into the processor circuitry 612. The input device(s) 622 can be implemented by, for example, an audio sensor, a microphone, a camera (still or video), a keyboard, a button, a mouse, a touchscreen, a track-pad, a trackball, an isopoint device, and/or a voice recognition system.

One or more output devices 624 are also connected to the interface circuitry 620 of the illustrated example. The output devices 624 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 620 of the illustrated example, thus, typically includes a graphics driver card, a graphics driver chip, and/or graphics processor circuitry such as a GPU.

The interface circuitry 620 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 626. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 600 of the illustrated example also includes one or more mass storage devices 628 to store software and/or data. Examples of such mass storage devices 628 include magnetic storage devices, optical storage devices, floppy disk drives, HDDs, CDs, Blu-ray disk drives, redundant array of independent disks (RAID) systems, solid state storage devices such as flash memory devices, and DVD drives.

The machine executable instructions 632, which may be implemented by the machine readable instructions of FIGS. 3-5, may be stored in the mass storage device 628, in the volatile memory 614, in the non-volatile memory 616, and/or on a removable non-transitory computer readable storage medium such as a CD or DVD.

FIG. 7 is a block diagram of an example implementation of the processor circuitry 612 of FIG. 6. In this example, the processor circuitry 612 of FIG. 6 is implemented by a microprocessor 700. For example, the microprocessor 700 may implement multi-core hardware circuitry such as a CPU, a DSP, a GPU, an XPU, etc. Although it may include any number of example cores 702 (e.g., 1 core), the microprocessor 700 of this example is a multi-core semiconductor device including N cores. The cores 702 of the microprocessor 700 may operate independently or may cooperate to execute machine readable instructions. For example, machine code corresponding to a firmware program, an embedded software program, or a software program may be executed by one of the cores 702 or may be executed by multiple ones of the cores 702 at the same or different times. In some examples, the machine code corresponding to the firmware program, the embedded software program, or the software program is split into threads and executed in parallel by two or more of the cores 702. The software program may correspond to a portion or all of the machine readable instructions and/or operations represented by the flowcharts of FIGS. 3-5.

The cores 702 may communicate by an example bus 704. In some examples, the bus 704 may implement a communication bus to effectuate communication associated with one(s) of the cores 702. For example, the bus 704 may implement at least one of an Inter-Integrated Circuit (I2C) bus, a Serial Peripheral Interface (SPI) bus, a PCI bus, or a PCIe bus. Additionally or alternatively, the bus 704 may implement any other type of computing or electrical bus. The cores 702 may obtain data, instructions, and/or signals from one or more external devices by example interface circuitry 706. The cores 702 may output data, instructions, and/or signals to the one or more external devices by the interface circuitry 706. Although the cores 702 of this example include example local memory 720 (e.g., Level 1 (L1) cache that may be split into an L1 data cache and an L1 instruction cache), the microprocessor 700 also includes example shared memory 710 that may be shared by the cores (e.g., Level 2 (L2_cache)) for high-speed access to data and/or instructions. Data and/or instructions may be transferred (e.g., shared) by writing to and/or reading from the shared memory 710. The local memory 720 of each of the cores 702 and the shared memory 710 may be part of a hierarchy of storage devices including multiple levels of cache memory and the main memory (e.g., the main memory 614, 616 of FIG. 6). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 702 may be referred to as a CPU, DSP, GPU, etc., or any other type of hardware circuitry. Each core 702 includes control unit circuitry 714, arithmetic and logic (AL) circuitry (sometimes referred to as an ALU) 716, a plurality of registers 718, the L1 cache 20, and an example bus 722. Other structures may be present. For example, each core 702 may include vector unit circuitry, single instruction multiple data (SIMD) unit circuitry, load/store unit (LSU) circuitry, branch/jump unit circuitry, floating-point unit (FPU) circuitry, etc. The control unit circuitry 714 includes semiconductor-based circuits structured to control (e.g., coordinate) data movement within the corresponding core 702. The AL circuitry 716 includes semiconductor-based circuits structured to perform one or more mathematic and/or logic operations on the data within the corresponding core 702. The AL circuitry 716 of some examples performs integer based operations. In other examples, the AL circuitry 716 also performs floating point operations. In yet other examples, the AL circuitry 716 may include first AL circuitry that performs integer based operations and second AL circuitry that performs floating point operations. In some examples, the AL circuitry 716 may be referred to as an Arithmetic Logic Unit (ALU). The registers 718 are semiconductor-based structures to store data and/or instructions such as results of one or more of the operations performed by the AL circuitry 716 of the corresponding core 702. For example, the registers 718 may include vector register(s), SIMD register(s), general purpose register(s), flag register(s), segment register(s), machine specific register(s), instruction pointer register(s), control register(s), debug register(s), memory management register(s), machine check register(s), etc. The registers 718 may be arranged in a bank as shown in FIG. 7. Alternatively, the registers 718 may be organized in any other arrangement, format, or structure including distributed throughout the core 702 to shorten access time. The bus 720 may implement at least one of an I2C bus, a SPI bus, a PCI bus, or a PCIe bus

Each core 702 and/or, more generally, the microprocessor 700 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 700 is a semiconductor device fabricated to include many transistors interconnected to implement the structures described above in one or more integrated circuits (ICs) contained in one or more packages. The processor circuitry may include and/or cooperate with one or more accelerators. In some examples, accelerators are implemented by logic circuitry to perform certain tasks more quickly and/or efficiently than can be done by a general purpose processor. Examples of accelerators include ASICs and FPGAs such as those discussed herein. A GPU or other programmable device can also be an accelerator. Accelerators may be on-board the processor circuitry, in the same chip package as the processor circuitry and/or in one or more separate packages from the processor circuitry.

FIG. 8 is a block diagram of another example implementation of the processor circuitry 612 of FIG. 6. In this example, the processor circuitry 612 is implemented by FPGA circuitry 800. The FPGA circuitry 800 can be used, for example, to perform operations that could otherwise be performed by the example microprocessor 800 of FIG. 8 executing corresponding machine readable instructions. However, once configured, the FPGA circuitry 800 instantiates the machine readable instructions in hardware and, thus, can often execute the operations faster than they could be performed by a general purpose microprocessor executing the corresponding software.

More specifically, in contrast to the microprocessor 800 of FIG. 8 described above (which is a general purpose device that may be programmed to execute some or all of the machine readable instructions represented by the flowcharts of FIGS. 3-5 but whose interconnections and logic circuitry are fixed once fabricated), the FPGA circuitry 800 of the example of FIG. 8 includes interconnections and logic circuitry that may be configured and/or interconnected in different ways after fabrication to instantiate, for example, some or all of the machine readable instructions represented by the flowcharts of FIG. 3-5. In particular, the FPGA 800 may be thought of as an array of logic gates, interconnections, and switches. The switches can be programmed to change how the logic gates are interconnected by the interconnections, effectively forming one or more dedicated logic circuits (unless and until the FPGA circuitry 800 is reprogrammed). The configured logic circuits enable the logic gates to cooperate in different ways to perform different operations on data received by input circuitry. Those operations may correspond to some or all of the software represented by the flowcharts of FIGS. 3-5. As such, the FPGA circuitry 800 may be structured to effectively instantiate some or all of the machine readable instructions of the flowcharts of FIGS. 3-5 as dedicated logic circuits to perform the operations corresponding to those software instructions in a dedicated manner analogous to an ASIC. Therefore, the FPGA circuitry 800 may perform the operations corresponding to the some or all of the machine readable instructions of FIGS. 3-5 faster than the general purpose microprocessor can execute the same.

In the example of FIG. 8, the FPGA circuitry 800 is structured to be programmed (and/or reprogrammed one or more times) by an end user by a hardware description language (HDL) such as Verilog. The FPGA circuitry 800 of FIG. 8, includes example input/output (I/O) circuitry 802 to obtain and/or output data to/from example configuration circuitry 804 and/or external hardware (e.g., external hardware circuitry) 806. For example, the configuration circuitry 804 may implement interface circuitry that may obtain machine readable instructions to configure the FPGA circuitry 800, or portion(s) thereof. In some such examples, the configuration circuitry 804 may obtain the machine readable instructions from a user, a machine (e.g., hardware circuitry (e.g., programmed or dedicated circuitry) that may implement an Artificial Intelligence/Machine Learning (AI/ML) model to generate the instructions), etc. In some examples, the external hardware 806 may implement the microprocessor 612 of FIG. 6. The FPGA circuitry 800 also includes an array of example logic gate circuitry 808, a plurality of example configurable interconnections 810, and example storage circuitry 812. The logic gate circuitry 808 and interconnections 810 are configurable to instantiate one or more operations that may correspond to at least some of the machine readable instructions of FIGS. 3-5 and/or other desired operations. The logic gate circuitry 808 shown in FIG. 8 is fabricated in groups or blocks. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 808 to enable configuration of the electrical structures and/or the logic gates to form circuits to perform desired operations. The logic gate circuitry 808 may include other electrical structures such as look-up tables (LUTs), registers (e.g., flip-flops or latches), multiplexers, etc.

The interconnections 810 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 808 to program desired logic circuits.

The storage circuitry 812 of the illustrated example is structured to store result(s) of the one or more of the operations performed by corresponding logic gates. The storage circuitry 812 may be implemented by registers or the like. In the illustrated example, the storage circuitry 812 is distributed amongst the logic gate circuitry 808 to facilitate access and increase execution speed.

The example FPGA circuitry 800 of FIG. 8 also includes example Dedicated Operations Circuitry 814. In this example, the Dedicated Operations Circuitry 814 includes special purpose circuitry 816 that may be invoked to implement commonly used functions to avoid the need to program those functions in the field. Examples of such special purpose circuitry 816 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 800 may also include example general purpose programmable circuitry 818 such as an example CPU 820 and/or an example DSP 822. Other general purpose programmable circuitry 818 may additionally or alternatively be present such as a GPU, an XPU, etc., that can be programmed to perform other operations.

Although FIGS. 7 and 8 illustrate two example implementations of the processor circuitry 612 of FIG. 6, many other approaches are contemplated. For example, as mentioned above, modern FPGA circuitry may include an on-board CPU, such as one or more of the example CPU 820 of FIG. 8. Therefore, the processor circuitry 612 of FIG. 6 may additionally be implemented by combining the example microprocessor 700 of FIG. 7 and the example FPGA circuitry 800 of FIG. 8. In some such hybrid examples, a first portion of the machine readable instructions represented by the flowcharts of FIGS. 3-5 may be executed by one or more of the cores 702 of FIG. 7 and a second portion of the machine readable instructions represented by the flowcharts of FIGS. 3-5 may be executed by the FPGA circuitry 800 of FIG. 8.

In some examples, the processor circuitry 612 of FIG. 6 may be in one or more packages. For example, the processor circuitry 700 of FIG. 7 and/or the FPGA circuitry 800 of FIG. 8 may be in one or more packages. In some examples, an XPU may be implemented by the processor circuitry 612 of FIG. 6, which may be in one or more packages. For example, the XPU may include a CPU in one package, a DSP in another package, a GPU in yet another package, and an FPGA in still yet another package.

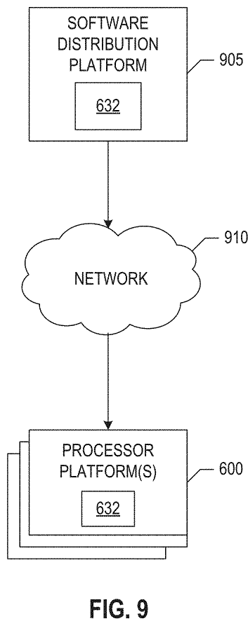

A block diagram illustrating an example software distribution platform 905 to distribute software such as the example machine readable instructions 632 of FIGS. 3-5 to hardware devices owned and/or operated by third parties is illustrated in FIG. 9. The example software distribution platform 905 may be implemented by any computer server, data facility, cloud service, etc., capable of storing and transmitting software to other computing devices. The third parties may be customers of the entity owning and/or operating the software distribution platform 905. For example, the entity that owns and/or operates the software distribution platform 905 may be a developer, a seller, and/or a licensor of software such as the example machine readable instructions 632 of FIG. 6. The third parties may be consumers, users, retailers, OEMs, etc., who purchase and/or license the software for use and/or re-sale and/or sub-licensing. In the illustrated example, the software distribution platform 905 includes one or more servers and one or more storage devices. The storage devices store the machine readable instructions 632, which may correspond to the example machine readable instructions 300, 400, 500 of FIGS. 3-5, as described above. The one or more servers of the example software distribution platform 905 are in communication with a network 910, which may correspond to any one or more of the Internet and/or any of the example network 106 described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 632 from the software distribution platform 905. For example, the software, which may correspond to the example machine readable instructions 300, 400, 500 of FIGS. 3-5, may be downloaded to the example processor platform 600, which is to execute the machine readable instructions 632 to implement the host orchestrator 110. In some example, one or more servers of the software distribution platform 905 periodically offer, transmit, and/or force updates to the software (e.g., the example machine readable instructions 632 of FIG. 6) to ensure improvements, patches, updates, etc., are distributed and applied to the software at the end user devices.

Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the claims of this patent.

The following claims are hereby incorporated into this Detailed Description by this reference, with each claim standing on its own as a separate embodiment of the present disclosure.

What is claimed is:

1. A non-transitory computer readable medium comprising instructions that, when executed, cause a machine to at least:
in response to detecting a first workload domain that is over-utilized, transmit a message to a message broker;
detect a second workload domain that is under-utilized; and
transfer a host from the second workload domain to the first workload domain.

2. The non-transitory computer readable medium of claim 1, wherein instructions, when executed, cause the machine to detect the first workload domain is over-utilized by detecting that resource utilization meets a threshold.

3. The non-transitory computer readable medium of claim 1, wherein the instructions cause the machine to detect that the second workload domain is under-utilized by comparing a resource utilization to a threshold.

4. The non-transitory computer readable medium of claim 1, wherein the instructions cause the machine to transmit a message to the message broker in response to detecting the host from the second workload domain is under-utilized.

5. The non-transitory computer readable medium of claim 1, wherein the instructions cause the machine to assign the host to a free resource pool.

6. The non-transitory computer readable medium of claim 1, wherein the instructions cause the machine to determine a projected utilization of a workload domain based on removal of a host.

7. The non-transitory computer readable medium of claim 6, wherein the instructions cause the machine to compare the projected utilization to an offer threshold.

8. An apparatus comprising:
memory;
instructions in the apparatus;
processor circuitry including one or more of at least one of a central processing unit, a graphic processing unit or a digital signal processor, the at least one of the central processing unit, the graphic processing unit or the digital signal processor having control circuitry to control data movement within the processor circuitry, arithmetic and logic circuitry to perform one or more first operations corresponding to instructions, and one or more registers to store a result of the one or more first operations, the processor circuitry to execute the instructions to:
in response to detecting a first workload domain that is over-utilized, transmit a message to a message broker;
detect a second workload domain that is under-utilized; and
transfer a host from the second workload domain to the first workload domain.

9. The apparatus of claim 8, wherein the processor circuitry is to execute the instructions to detect the first workload domain is over-utilized by detecting that resource utilization meets a threshold.

10. The apparatus of claim 8, wherein the processor circuitry is to execute the instructions to detect that the second workload domain is under-utilized by comparing a resource utilization to a threshold.

11. The apparatus of claim 8, wherein the processor circuitry is to execute the instructions to transmit a message to the message broker in response to detecting the host from the second workload domain is under-utilized.

12. The apparatus of claim 8, wherein the processor circuitry is to execute the instructions to assign the host to a free resource pool.

13. The apparatus of claim 8, wherein the processor circuitry is to execute the instructions to determine a projected utilization of a workload domain based on removal of a host.

14. The apparatus of claim 13, wherein the processor circuitry is to execute the instructions to compare the projected utilization to an offer threshold.

15. A method comprising:
in response to detecting a first workload domain that is over-utilized, transmitting a message to a message broker;
detecting a second workload domain that is under-utilized; and
transferring a host from the second workload domain to the first workload domain.

16. The method of claim 15, further comprising detecting the first workload domain is over-utilized by detecting that resource utilization meets a threshold.

17. The method of claim 15, further comprising detecting that the second workload domain is under-utilized by comparing a resource utilization to a threshold.

18. The method of claim 15, further comprising transmitting a message to the message broker in response to detecting the host from the second workload domain is under-utilized.

19. The method of claim 15, further comprising assigning the host to a free resource pool.

20. The method of claim 15, further comprising determining a projected utilization of a workload domain based on removal of a host.

21. The method of claim 20, further comprising comparing the projected utilization to an offer threshold.
